(19) United States
(12) Patent Application Publication
(10) Pub. No.: US 2004/0004829 A1
(43) Pub. Date: Jan. 8, 2004

(54) Illuminating, heating or cooling a consumer product

(76) Inventor: Nini Policappelli, Los Angeles, CA (US)

Correspondence Address: GREENBERG TRAURIG LLP, 2450 COLORADO AVENUE, SUITE 400E, SANTA MONICA, CA, 90404, US

(21) Appl. No.: 10/222,517

(22) Filed: Aug. 17, 2002

Related U.S. Application Data
(60) Provisional application No. 60/317,885, filed on Sep. 7, 2001.

(51) Int. Cl. B65D 23/00; F21V 33/00; B65D 23/08; B65D 23/12; B65D 23/02

(52) U.S. Cl. 362/101; 215/386; 215/12.2

(57) ABSTRACT

A consumer item including a body for containing at least one of a liquid solid or other consumable product, the body having been or receiving a material responsive to light pressure or the like such that activation of the material causes illumination and/or phosphorescence and a fluorescent effect by the material and/or the contents of the container and/or the body. In other cases or in addition the activation of the device by breakage of bonds or barriers can effect a temperature change to the consumer product.

This application claims priority and benefit of U.S. Provisional Application Serial No. 60/317,885, entitled “CONSUMER PRODUCT ILLUMINATION”, filed Sep. 7, 2001 and the contents thereof are incorporated herein by reference.

### BACKGROUND OF THE INVENTION

Field of the Invention

The present invention relates to consumer products. In particular, the invention is concerned with illumination, heating or cooling aspects for such products.

Many different forms of consumer products are available in the nature of glass, plastic and the like. Such products can be for containing liquids, fluids and solids or other products to be consumed. The invention is specifically directed to consumer products for containing such consumable items. Such consumer products are continually improved in their appearance and attractiveness. This invention is directed to another form of improving the attractiveness of such consumer products, and/or for providing heating and/or cooling of the contents of such products.

### INVENTION SUMMARY

According to the invention, there is provided a consumer product in the form of a container for a consumable product which can be a liquid such as alcohol, wine, water, soft drink, ice or other solid consumable items, such as different foods. The containing item may be in the form of a bottle, glass, bucket, plate or dish. The consumable product is ideally contained in the bottle, glass, bucket, plate or dish. The consumable product is ideally formed of glass or plastic and has a component in or related to the body of the consumer product which is responsive to activated light thereby to enhance the appearance of the container from an ambient state.

The body of the consumer product can contain phosphorous or other phosphorous pigments, luminescent pigments or fluorescent such that when the consumer product is activated by a light source, the consumer product becomes activated to a higher degree of illumination than would otherwise exist in its ambient state. As such, when the consumer product is activated by a light source it tends to glow.

The light source can be a battery driven lighting element with a light bulb affixed to the battery, and once activated, the location of the light bulb relative to the wall of the consumer product is such that the light travels essentially within the wall forming the consumer product. The light source can be contained in a wall or the base of the consumer product, and a suitable mating engagement can be achieved for affixing the light source to the consumable product. In other forms of the invention, certain container products are made with an arched base, and the light source can fit within that base and, when activated, the light from the light source lights up the bottle and its contents appropriately. Different color lamps and lenses can be provided to the light source.

In another form of the invention the source of the light may also contain one or more chemicals which is activated can cause the consumer product to be heated or cooled. The heating or cooling can be effected without the lighting activation. The chemical is contained in a vessel or package ideally to surround, enclose or otherwise extend about the consumer product in as broad a manner as possible to extend the heating or cooling effect broadly to the consumer product.

The foregoing and other objects, features and advantages of the invention will be apparent from the following detailed description of the preferred embodiments which makes reference to several drawing figures.

### BRIEF DESCRIPTION OF THE DRAWINGS

FIG. 1 is a side view representation of a bottle for consumer products such as liquor, perfumes or the like, and showing a reservoir in the wall of the bottle for receiving a light source.

FIG. 1a is a cut-away version of part of the bottle showing the receptacle for a light source, and separately the battery light source adjacent to the receptacle.

FIG. 2 is a representation of a bottle with a reservoir formed in the base area and a light source located below the bottle. The light source effectively in light-up ornamentation on the bottle.

FIG. 2a is a representation of a light source for location in the reservoir.

FIG. 3 is a representation of a liquor bottle with a light source mounted in the cap of the bottle, the light source having a battery and suitable lamp unit. The lighting effect will be to the contents of the bottle and/or the wall of the bottle. As such, the label can be appropriately illuminated from within, and the label can be formed to have an effective consumer appeal reaction caused by the light source.

FIG. 3a is a side sectional view of a cap showing a light source in the cap.

FIG. 4 is a side view of an ice bucket showing a light source mounted in contiguity with the base of the ice bucket.

FIG. 5 is a side view of wineglass showing a light source mounted at the base of a stem.

FIG. 6 is a plate, such as a server plate, with a reservoir in the base and a light source mounted in that reservoir.

FIG. 7 is a side view of a bottle wrapped with phosphoric, fluorescent and luminescent elements which are responsive to a light source mounted in the base of the bottle.

FIG. 7a is a different representation of fluorescent element with a consumer item.

FIG. 7b shows two representations of phosphorescent, luminescent and fluorescent filament in the body of a consumer item and for use in a situation without a light source.

### DETAILED DESCRIPTION OF THE PREFERRED EMBODIMENTS

In the following description of the preferred embodiments reference is made to the accompanying drawings which form the part thereof, and in which are shown by way of illustration of specific embodiments in which the invention may be practiced. It is to be understood that other embodiments may be utilized and structural and functional changes may be made without departing from the scope of the present invention.

A consumer product in the nature of a bottle 10 contains elements 11 spaced about the bottle from the base to the top. In the wall 12 there is a reservoir 13 for receiving a lighting source 14. The reservoir 13 includes a curved inner zone 15 and a circumferential slot 16. The slot 16 is for receiving a circumferential lip about the lighting source 14.

The lighting source 14 itself includes a battery 18 in electrical engagement with a lamp unit 19 which has a round face 20 for engagement with the face 15. The on/off switch 21 may be larger at the base of the battery. Also part of the mounting is a circumferential shoulder 22 which engages the outside of the wall 12. Between the lip 17 and shoulder 22 there is a firm engagement of the lighting source with the bottle. When the lighting source is activated light from the lamp activates the wall of the bottle 12 to effectively light the bottle relative to the ambient condition. As indicated the elements 11 may be more reactive to light and as such may be fluorescent, phosphorescent or luminescent, and of a nature that they are more responsive and become more lit up relative to the base component of the bottle 10. Additionally, the light may provide luminescence to the contents of the bottle.

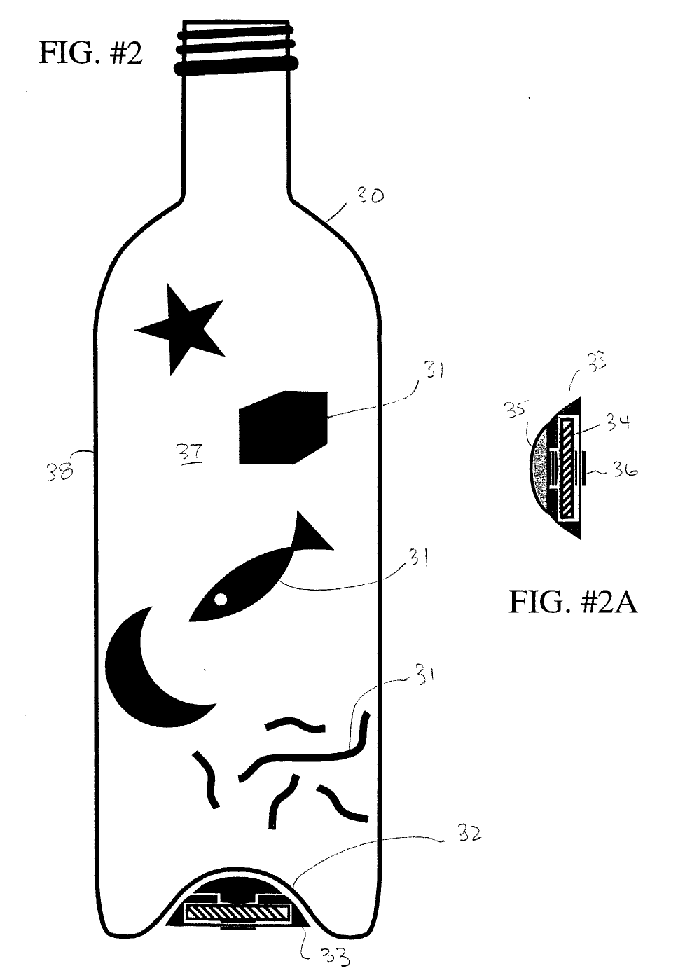

In FIG. 2 is shown a bottle 30 which has arranged around the body of the bottle different ornamentations 31. The bottle 30 has a raised reservoir 32 which is common in many liquor bottles and wine bottles. Within the reservoir 32 there is located a lighting element 33. Lighting element 33 has a battery 34 which is interactive with a lamp element 35. A suitable switch 36 can be provided. The raised reservoir 32 is a convenient location for the lighting element 33 and its effective operation causes light to emanate from the lamp 35 to illuminate the contents 37 of the bottle or the wall 38 of the bottle and also the ornamentation 31 above the bottle. Once again, the ornamentation 31 can have a different reactive effect to the light from the light source 35 and can fluoresce or phosphorous or it be illuminated differently to the contents of the bottle or the wall of the bottle.

In FIG. 3 there is shown a liquor bottle 40 which has a label 41 which has a relatively opaque portion 42 and also transparent portions 43. The cap 44 to the bottle has a sidewall 45 and a top 46. Mounted in the cap 44 is a light source 47 which includes a battery 48 and a lamp 49. A suitable electrical content 50 exists between the lamp 48 and the light 49. A switch 51 on the top of the cap 44 is activated to cause closure of the contents between the battery and the lamp 49. When the lamp 44 is activated, light penetrates the contents 52 of the bottle as well as the wall 53 of the bottle. The lighting up of the contents of the bottle and the wall of the bottle can cause luminescence to shine more brightly through the transparent spaces 43 which could include parts of the label and thereby enhance the effect of the bottle.

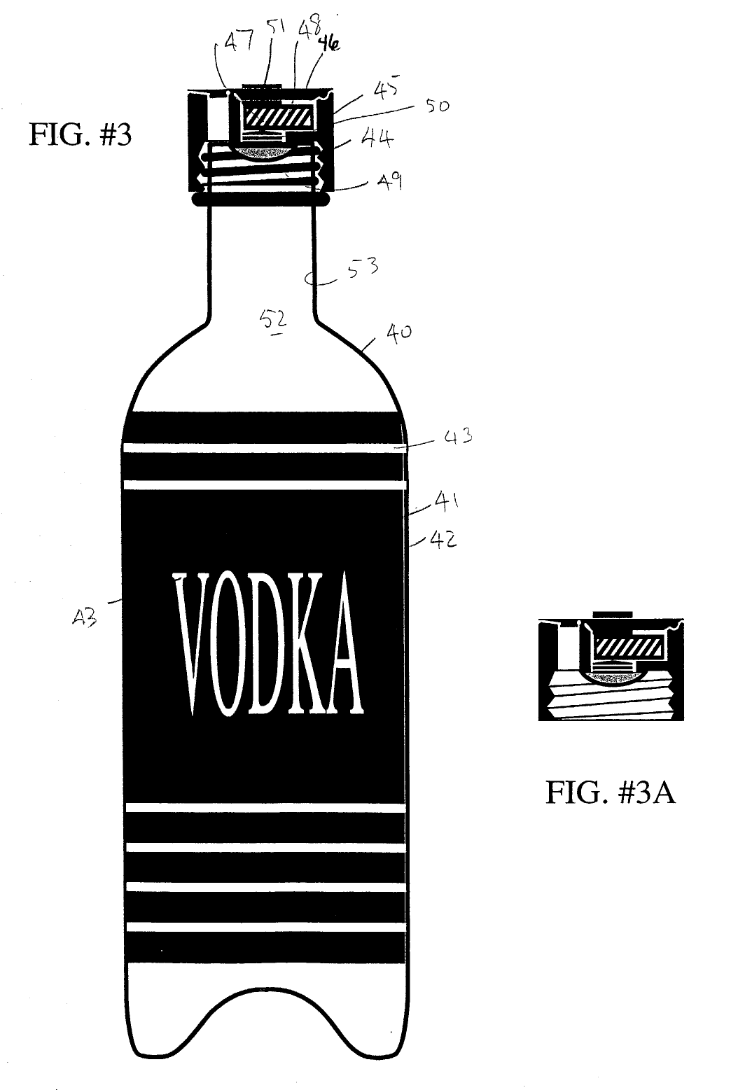

In FIG. 4, there is shown a consumer item in the nature of an ice bucket 60. The base 61 of the ice bucket 60 includes a hollowed out type space or reservoir for locating a light source 62. Once again the light source includes a battery 63 and a bulb 64 which are an electrical content and there is an appropriate switch 65. Activation of the light source causes the lamp 64 to radiate light and thereby cause greater luminescence of the wall 66 of the ice bucket and all of the contents 67 of that bucket. Where there is a suitable ornamentation 68 around the ice bucket can be illuminated differently. The qualities of the material forming the ice bucket and the ornamentation 68 can be different so that the effect and responsiveness to the light source varies by virtue of the reaction to light from the light source.

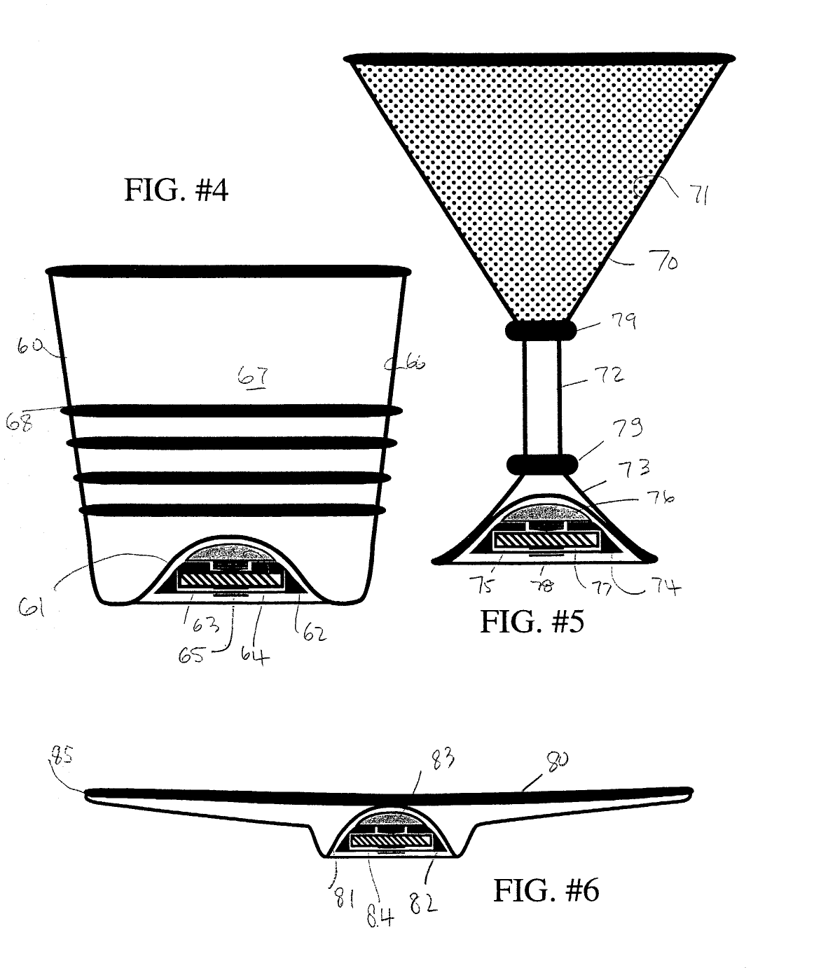

In FIG. 5, there is shown a wineglass 70 which has a top portion 71 for holding a beverage, a stem 72 and a base 73. Within the base, there is located a light source 74. The light source includes a battery 75 and a lamp 76 which are on an electrical contact through contact 77. A switch 78 in the nature of a push contact is provided at the base of the light source. The activation of the light source 74 causes light to pass up the stem of the glass and into the walls 71 of the portion for receiving liquid. The wineglass can be made of different materials in the portion containing liquid 71, the stem 72 and the base 73 so different lighting effects can be achieved. Also different ornamentation can be provided around the glass, such as rings 79 about the stem. This causes different illumination effects on the glass.

In FIG. 6 there is shown a plate 80 which has a receptacle 81 for receiving a light source 82. The light source includes the lamp 83 which reacts with the battery 84 in the manner described above. Activation of the light source 82 causes the surface 85 of the plate to be illuminated or to impart a phosphoric or fluorescent effect. This can enhance the contents displayed on the surface 85 of the plate.

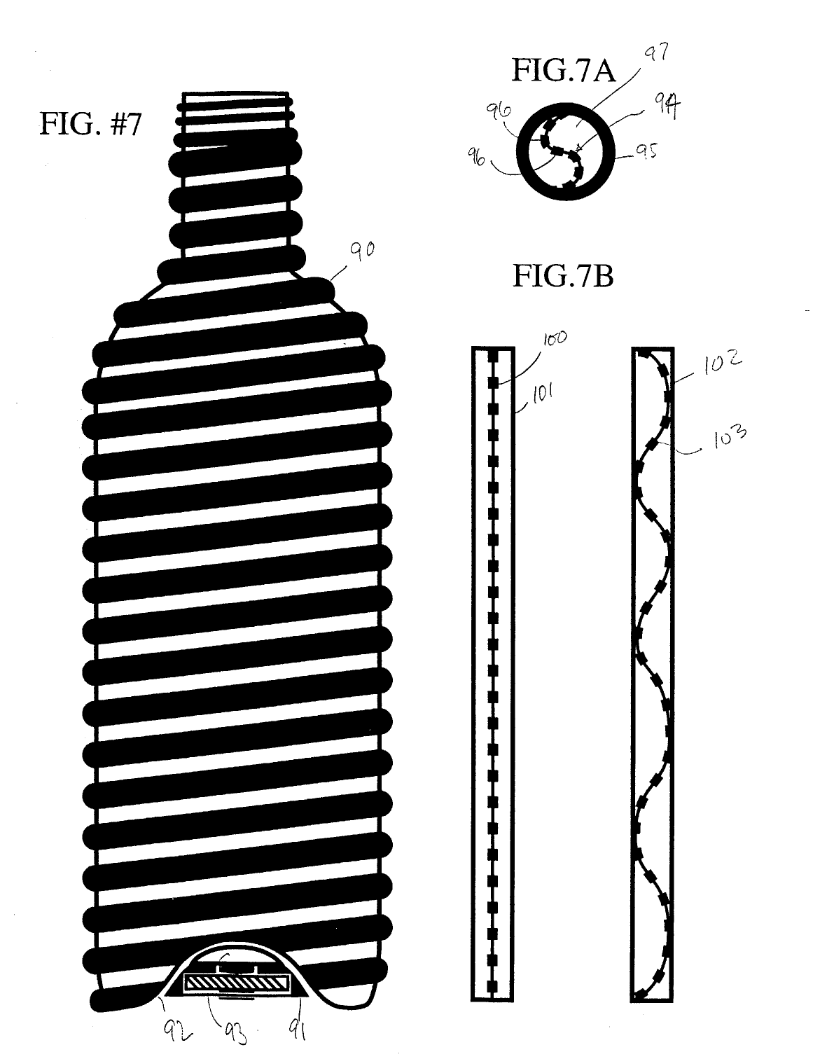

In FIG. 7 there is shown a bottle which is wound with a phosphorescent luminescent or fluorescent material 90. A light source 91 is located in the base 92 of the bottle and activation of the light source causes light to emanate from the lamp 93 and to activate the spiraling material 90 which is around the bottle. This causes an illumination effect to the bottle, its contents and the spiraling material which is determined by the material characteristics of the bottle.

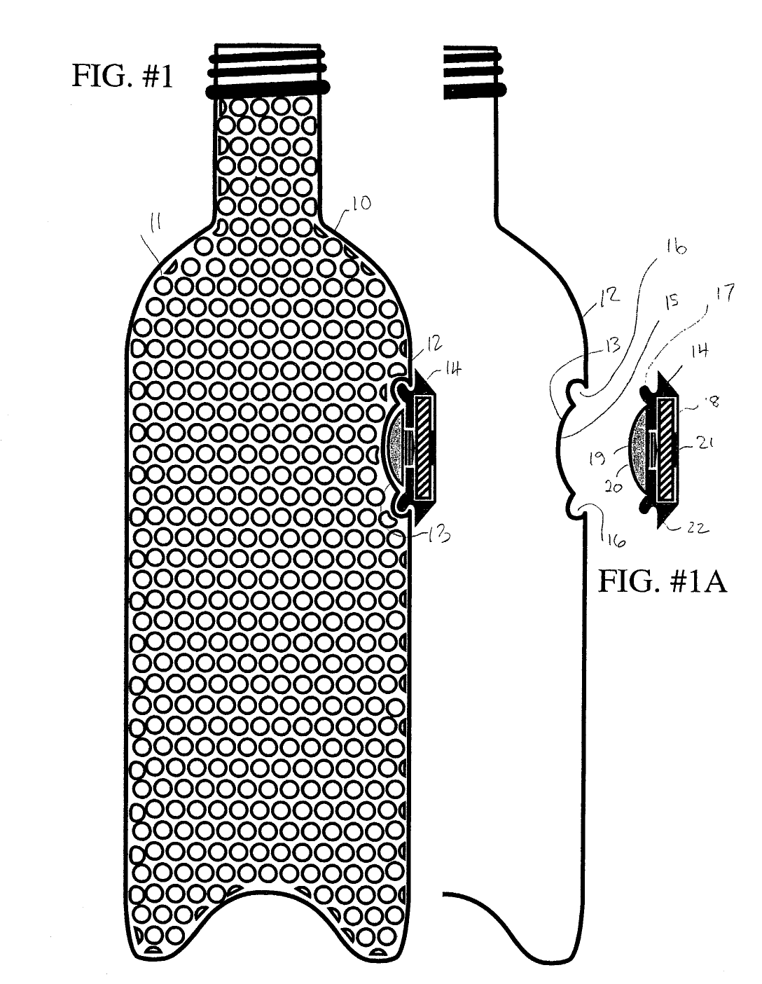

In FIG. 7a, there is shown a phosphorescent material 94 contained within a tubular material 95 and this material can have components or cells 96 which can be activated to emanate light. These kinds of devices are commonly known and have different chemical characteristics such that when the cells 96 are broken, they react with different materials 97 and the surrounding material thereby to impart light. Such a light effect can be achieved without a lamp source and there is an inherent light which is emanated from the chemical reaction, wherein chemical bonds of the source 96 are broken and the reaction takes place with the ambient chemicals in the surrounding portions 97. Such a lighting effect may only operate for a relatively short period of time, namely, until the chemical reaction is essentially complete. This form of generating light for use with a consumer product could be used in any of the embodiments illustrated in FIGS. 1 through 7 as appropriate. The light generation source may be in addition to or in place of a light generator caused by the lamp and battery.

In FIG. 7b on the left-hand side there is shown chemical chains 100 in the wall 101 of a container for a consumer item. This container or wall 101 can be either flexible or solid. The chemical chains 100 may be responsive to the onset stimulation of light, such as enhanced fluorescent or incandescent or ultraviolet light such as to activate the chemicals 100 in the wall. This is typical. Once the source of light fluorescence or phosphoric stimulation is removed, the elements 100 can radiate phosphorescence or light as required. The elements 100 can be distributed anywhere on the surface or within the wall of the consumer product, such as a container bottle glass plate or the like.

In FIG. 7b on the right-hand side, there is shown a wall 102 with a different formation 103 of the cells which are sinusoidally disposed in the wall 102. The operation of this configuration can be either with a light or a light source in contiguity with the consumer product or tentatively and/or additionally the removal of a light source or light stimulation from the container cannot necessarily cause an immediate diminishment of the phosphorescence, fluorescence or illumination of the cells. This would depend upon the nature of the cells 103 which are selected to be part of the chemical construct for emanating light.

Many other forms of the invention exist each differing from the other in matters of detail only. The light responsive chemical or surface of body for the consumer item may be incorporated in the glass or just glazed on a surface of the glass as required. A suitable glowing effect can be achieved on the glass or in relief such that the light can appear to be captured within the container and just pass through transparent or open ports in the container or about the container. Different techniques can be used for forming patterns on the container, for instance, laser printing, lamination or baking can be used to affect a layer or formation of light responsive particles on or with the body of the consumer item.

Many other forms of the invention exist each differing from others in matters of detail only. Ideally, since the fluorescence, phosphorescence or luminescence material may come into contact with a consumable beverage or food, the material should be non-toxic.

Many modifications and variations are possible in the light of the above teaching. The foregoing is a description of the preferred embodiments of the invention and has been presented for the purpose of illustration and description. It is not intended to be exhaustive and so limit the invention to the precise form disclosed.

In some other embodiments the material 90 which is wound around the container may contain one or more chemicals to effect heating or cooling. The effective change in temperature of the material inside a tubular material constituting the spiral material can be achieved by breaking a seal manually separating two or more other devices inside the tube which if broken can cause an energy to be transferred to the chemicals to effect a change of heat.

In some cases the elongated spiral body is divided into different cells. In this manner different cells can be activated at different times by a user. The material can be flexible, and can be made of a soft or thin gauge metal.

In some situations a light effect can additionally be created by the breakage of one or more barriers in the tube 90.

In different cases the tube can be formed of different components, such that the portion of the tube which extends outwardly can be an insulation and/or it can be darkened. In this manner the lighting changes and/or temperature changes effects can be concentrated into the product or in a particular direction. In this manner a more efficient temperature transfer can be effected and/or light change can be attained. Also, by having the outside of the tube, formed of an insulting material or covered by an insulating material, there is less likelihood of this user being subjected to discomfort by an inadvertent temperature change.

The tube can be an elastic and/or flexible type spring. Also, it can be supplied separately to the consumer product. As such it can serve a useful purpose of being a replaceable source for use with a consumer product. Several of such devices may be used repetitively with the product to achieve the required temperature change. Also, in some cases, the activation of the chemicals is effected by twisting the metal along its length or preferably at the end in the manner similar to twisting a cap or a container neck.

In other forms of the invention there can be a label which is phosphorescent, fluorescent or luminescent and have an appropriate pigment in the label. Such label can be applied to a nontransparent container such as aluminum or other metal containers. The phosphorescent, fluorescence or luminescence can be directly or indirectly activated by charged light or ambient light. In other forms, there can be a switch to operate the flashlight. The switch can have one of three positions: on, off or an intermittent position of blinking on and off. There can be a sensor on the container or label such that a user touching the container or label can activate the switch to go into any one of the three modes.

The foregoing is a description of the preferred embodiments of the invention and has been presented for the purposes of illustration and description. It is not intended to be exhaustive or to limit the invention to the precise form disclosed.

While the specification describes particular embodiments of the present invention, those of ordinary skill can devise variations of the present invention without departing from the inventive concept.

What is claimed is:

1. A container including a body for containing at least one of a liquid, solid or other consumable product, the body selectively having, being formed of or receiving a material responsive to light such that activation of the material causes at least one of illumination or phosphorescence and a fluorescent effect by at least one of the material or the contents of the container or the body.

2. A consumer product including a light source, the light source selectively being a chemical in, with or related to the body of the consumer item such that the interaction of different gases or chemicals causes a phosphorescence and/or fluorescence and/or illumination, when such interaction is activated.

3. A container as claimed in claim 1 including a light source mounted in contiguity with the body.

4. A container for a consumer product comprising a label, the label including at least one of a phosphorescent or fluorescent or luminescent pigment, the pigment being on a selected part of the label or printing on at least one of the label or on the container, and the container being selectively of a transparent material or a nontransparent material.

5. A container as claimed in claim 1 or claim 4 including a sensor and a flashlight, the sensor being responsive to touch to operate a switch, such that the switch causes the flashlight to be responsive into at least one of three modes, namely, the on mode, the off mode or a blinking on/off mode.

6. A container including a body for containing at least one of a liquid, solid or other consumable product, the body selectively having, being formed of or receiving a material around the outer surface of the container, the material having a wall for containing selected chemicals normally separated and when interacting in a non-separated state react to generate a change in temperature of the chemicals as a result of a chemical reaction, the wall of the material being responsive to pressure under the action of finger pressure from a consumer thereby to activate the contents by causing the separation of the chemicals to change, whereby the materials are activated such that under the action of pressure there is caused a change in temperature to the wall and thereby the contents of the container.

7. A container as claimed in claim 6 including a light source, the light source selectively being a chemical in, with or related to the body of the consumer item such that the interaction of different gases or chemicals causes a phosphorescence and/or fluorescence and/or illumination, when such interaction is activated.

8. A container as claimed in claim 7 including a light source mounted in contiguity with the body.

9. A container as claimed in claim 6 for a consumer product comprising a label, the label including at least one of a phosphorescent or fluorescent or luminescent pigment, the pigment being on a selected part of the label or printing on at least one of the label or on the container, and the container being selectively of a transparent material or a non-transparent material.

10. A container as claimed in claim 6 including a sensor and a flashlight, the sensor being responsive to touch to operate a switch, such that the switch causes the flashlight to be responsive into at least one of three modes, namely, the on mode, the off mode or a blinking on/off mode.

11. A container as claimed in claim 1 wherein the reactive material is contained in a spiral material about the container.

12. A container as claimed in claim 6 wherein the reactive material is contained in a spiral material about the container

13. A container as claimed in claim 7 wherein the reactive material is contained in a spiral material about the container.

14. A spiral material comprising reactive material, the spiral being for location about spiral material about a container, the container being for containing at least one of a liquid, solid or other consumable product, the spiral material being for location around the outer surface of the container, the material having a wall for containing selected chemicals normally separated and when interacting in a non-separated state react to generate a change in temperature of the chemicals as a result of a chemical reaction, the wall of the material being responsive to pressure under the action of finger pressure from a consumer thereby to activate the contents by causing the separation of the chemicals to change, whereby the materials being activated under the action of pressure causes a change in temperature to the wall and thereby the contents of the container.

15. A spiral material comprising reactive material, the spiral being for location about spiral material about a container, the container being for containing at least one of a liquid, solid or other consumable product, the spiral material having a wall for containing selected chemicals material responsive to light such that activation of the material causes at least one of illumination or phosphorescence and a fluorescent effect by at least one of the material or the contents of the container or the body.
